(19) United States
(12) Patent Application Publication
(10) Pub. No.: US 2024/0391181 A1
(43) Pub. Date: Nov. 28, 2024

(54) INDUCTION EMBEDDED BOND LAYER FOR FIBER REINFORCED THERMOPLASTIC PIPE

(71) Applicant: Fiber Glass Systems, L.P., Dover, TX (US)

(72) Inventors: James Pisarkiewicz, San Antonio, TX (US); David Wayne Granderson, San Antonio, TX (US)

(21) Appl. No.: 18/667,553

(22) Filed: May 17, 2024

Related U.S. Application Data
(60) Provisional application No. 63/503,610, filed on May 22, 2023.

(51) Int. Cl. B29C 65/36; B29C 65/34; B29C 65/54; B29K 663/00; B29K 709/08; B29L 23/00

(52) U.S. Cl. CPC B29C 65/3668; B29C 65/3492; B29C 65/54; B29K 2663/00; B29K 2709/08; B29L 2023/22

(57) ABSTRACT

A pipe may include an inner thermoplastic pipe, an outer layer of a fiber reinforced laminate, and a bond material. The bond material may be disposed between the inner thermoplastic pipe and the outer layer of fiber reinforced laminate. The bond material may be partially embedded within the inner thermoplastic pipe. At least one of the inner thermoplastic pipe or the bond material may include an induction heating compatible material (IHCM).

### CROSS-REFERENCE TO RELATED

This patent application claims the benefit of U.S. Provisional Patent Application No. 63/503,610, filed May 22, 2023, which is incorporated by reference herein in its entirety.

### TECHNOLOGICAL FIELD

The present disclosure relates to pipe. More particularly, the present disclosure relates to fiber reinforced thermoplastic pipe. Still more particularly, the present disclosure relates to fiber reinforced thermoplastic pipe that is manufactured at least in part using induction heating.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Pipes can be used to transport one or more of liquids, gasses, and slurries. A pipe may include a wall for containing the transportable material, and a bore for carrying the transportable material. The wall may include one or more materials that are connected by one or more of glue, fusing, or mechanical bonding.

A thermoplastic inner pipe may be reinforced with a fiber reinforced laminate applied over the inner pipe. For example, in some cases, a glass reinforced epoxy may be provided on an outer surface of a thermoplastic inner pipe. Due to material incompatibilities or other factors, the bond between the fiber reinforced laminate and the inner thermoplastic pipe may be relatively weak. As a result, over time, extended use, and/or due to pressurization and depressurization cycles, a portion of the inner pipe may delaminate from the fiber reinforced laminate.

### SUMMARY

In an example a pipe may include an inner thermoplastic pipe, an outer layer of a fiber reinforced laminate, and a bond material. The bond material may be disposed between the inner thermoplastic pipe and the outer layer of fiber reinforced laminate. The bond material may be partially embedded within the inner thermoplastic pipe. At least one of the inner thermoplastic pipe or the bond material may include an induction heating compatible material (IHCM).

In an example a method of manufacturing a pipe may include wrapping an inner thermoplastic pipe with a bond material, where at least one of the inner thermoplastic pipe and the bond material include an induction heating compatible material (IHCM). The method may also include using an induction heater, heating the IHCM to soften the inner thermoplastic pipe so that the bond material partially embeds within the inner thermoplastic pipe. The method may also include applying an outer layer of fiber reinforced laminate over the inner thermoplastic pipe and bond material.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows an example of fiber reinforced thermoplastic pipe, according to one or more examples.

FIG. 2 is a perspective view of an example of a portion of fiber reinforced thermoplastic pipe showing several layers of the pipe, according to one or more examples.

FIG. 3 is a schematic cross-sectional view of the pipe of FIG. 2, according to one or more examples.

FIG. 4 is a diagram depicting an example of a method for manufacturing the pipe, according to one or more examples.

FIG. 5 is a perspective view of an example of portions of a pipe being manufactured and portions of a system for manufacturing the pipe, according to one or more examples.

FIG. 6 is a perspective view of an example of portions of a pipe being manufactured and portions of a system for manufacturing the pipe, according to one or more examples.

### DETAILED DESCRIPTION

The present disclosure relates to a fiber reinforced plastic pipe that is manufactured using induction heating to partially embed a bond material within an inner thermoplastic pipe. After embedding, the bond material may assist with bonding to a layer of fiber reinforced laminate that is applied over the inner thermoplastic pipe. This may increase the strength of the bond between the inner thermoplastic pipe and fiber reinforced laminate.

Induction heating can be used to heat an induction heating compatible material (IHCM). An IHCM may be an at least partially electrically conductive material and, for example, may include a metal. Induction heating may heat the IHCM at least in part by inducing an electric current in the IHCM using at least one of an electric, a magnetic, or an electromagnetic field. The current induced in the IHCM may result in heat due to the resistance of the IHCM. In this way, heating of the IHCM may be accomplished without direct physical contact between the energy source generating the field and the IHCM. Additionally, the IHCM may allow for focused heating. For example, if the IHCM is within a material, the IHCM may be used to heat the material from the inside out.

The reinforced thermoplastic pipe may be a spoolable plastic pipe or a rigid plastic pipe. Spoolable plastic pipe may be desirable because it may be lightweight, flexible, easy to install, and/or cost-saving. A length of spoolable pipe may be able to be stored and transported in one piece on a spool or reel, for example. The length of spoolable pipe may be able to be installed in one continuous piece without joints, such as by unwinding the pipe from a spool. This may save time, save installation cost, allow installation where otherwise impractical, or result in a stronger installation. Rigid plastic pipe may be desirable because it may be more robust and/or more compact to transport. Rigid plastic pipe may be transported in a number of rigid sections of a specified length. During installation, respective rigid sections may be glued, bonded, or otherwise joined together to form a longer section of pipe. Rigid pipe may be able to be manufactured in a larger diameter than spoolable pipe.

A plastic pipe may be configured to include one or more layers of material in the wall. For example, a plastic pipe may include one or more layers of thermoplastic material in the wall and one or more layers of fiber reinforced laminate in the wall. The layers of thermoplastic and fiber reinforced laminate may be combined by one or more of glue or fusing. In an approach, one or more of a glue or resin may be applied between the layers to bond the layers.

The present inventors have recognized, among other things, that the layers of thermoplastic and fiber reinforced laminate pipe may separate, delaminate, or become unfused. For example, during service, the bore of the pipe may experience a specified service pressure, which may be from a liquid, gas, or slurry. A portion of the liquid, gas, or slurry may leak into the bonding region between the inner thermoplastic layer and the outer reinforced laminate. This may occur at a joint between pipe sections or at an imperfection in the inner thermoplastic pipe. When the service pressure inside the bore of the pipe is reduced, the liquid, gas, or slurry that has leaked into the bonding region may not have time to escape to equalize pressure, and a positive pressure may be developed in the bonding region. This pressure may cause the inner thermoplastic layer and outer layer of fiber reinforced laminate to partially separate, partially delaminate, or become partially unfused. This may result in the inner thermoplastic layer collapsing. This may degrade one or more properties of the pipe including strength, imperviousness, bore size, or rigidity. The delamination may occur in a single depressurization event or over multiple depressurization events.

Alternatively or in addition, the permeability of the gas through the inner liner may also be characteristic of the fluid and barrier material. For example, the fluid, or some components of the fluid, may be able to permeate the wall (i.e. flow of fluid atoms through the inner liner). As the fluid/fluid components permeate it can accumulate throughout and within the permeable materials in the pipe wall, such as at locations like voids or discontinuities in the pipe construction materials. Because the rate of permeation may be much slower than the rate at which end users would like to relieve the pipe of pressure, when internal fluid pressure is reduced a significant amount of pressure can still exist at the voids and discontinuities relative to the pipe bore. This remaining pressure can result in the debonding of the layers of the pipe and the collapse of inner layers.

The present inventors have recognized, among other things, that a bond material may be disposed between the inner thermoplastic pipe and the outer layer of fiber reinforced laminate to improve the strength of the bond. This bond material may help to strengthen the bond between the layers by partially embedding within the thermoplastic pipe to form a mechanical bond with the thermoplastic pipe and forming a strong chemical bond with the glue or resin used in the fiber reinforced laminate. For example, the bond material may be selected to form a strong bond with the fiber reinforced laminate. One or more of the inner thermoplastic pipe or the bond material may be heated to allow the bond material to partially embed within the inner thermoplastic pipe, which may allow for the formation of a mechanical bond.

The bond material or inner thermoplastic pipe may be heated at least in part using induction heating, which may include induction heating of an IHCM within one or more of the inner thermoplastic pipe or the bond material. This may result in a production process that is more efficient, more cost-effective, and/or quicker than a production process using conductive, radiant, or convective heating alone. In an example, a pipe constructed at least in part using induction heating may be more consistent or stronger than a pipe constructed without using induction heating. In an example, a pipe manufactured at least in part using induction heating may cool quicker or may not require as much cooling capacity to cool to a specified temperature.

The present inventors have recognized, among other things, that the heat input in a pipe manufacturing process may cause thermal expansion of the pipe, which may result in stress within the finished pipe. This may be helped by reducing the overall heat input in the pipe manufacturing process. Using induction heating in the manufacturing process may reduce the overall heat input. Additionally, induction heating may provide rapid, targeted heating to avoid heating incompatible materials.

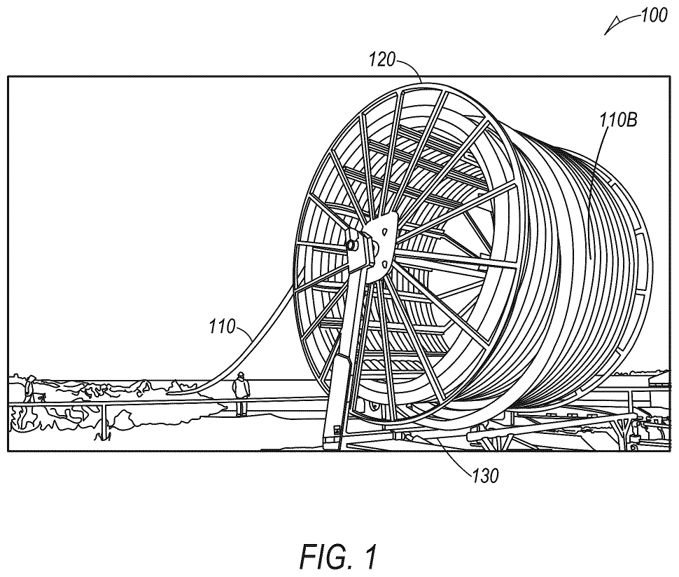

FIG. 1 shows an example 100 of a pipe installation. FIG. 1 shows pipe 110 being installed off of a spool 120. The spool 120 contains a length of pipe 110B. The length of pipe 110B may be continuous on the spool 120, which may allow the entire length of pipe 110B to be installed without connections or joints. The spool 120 may be stored on a portable trailer 130 which may allow the pipe to be transported from a location of storage or manufacturing to the location of installation and may provide for moving the spool 120 along the installation site while the pipe 110 is being unwound off of the spool 120.

The pipe 110 may be flexible to allow the pipe 110 to be spooled on and off the spool 120. The diameter of the spool 120 may be selected to allow the pipe 110 to be spooled without damaging the pipe 110. The pipe 110 may have a selected strength and durability that allows the pipe 110 to be used in harsh environments. The pipe 110 may be used to carry a variety of liquids, gasses, and slurries. In an example, the pipe may carry water, including a mixture of water and other chemicals.

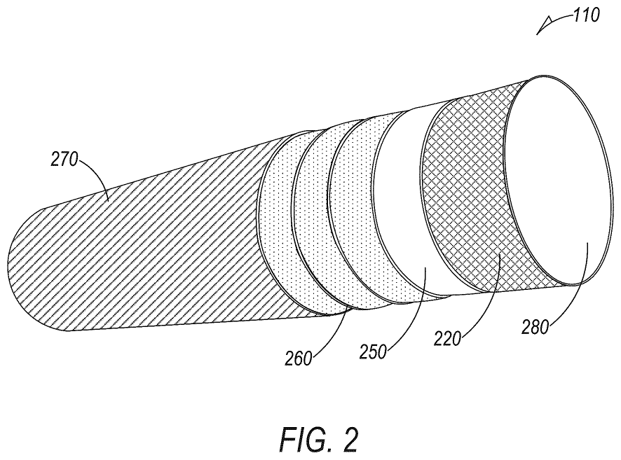

FIG. 2 is a perspective view of an example of a portion of a pipe 110. FIG. 2 shows that the pipe 110 may include an inner thermoplastic pipe 220, a bonding layer material 250, one or more outer layers of fiber reinforced laminate 260, and a thermoplastic wear-resistant layer 270.

The inner thermoplastic pipe 220 may be an unreinforced thermoplastic shell. The inner thermoplastic pipe 220 may be an extruded pipe, and may have a selected inner diameter, outer diameter, and wall thickness. The inner thermoplastic pipe 220 may be circular or substantially circular, and the thickness of the walls may be consistent or substantially consistent. The bore 280 of the pipe 110 may be defined by a bore of the inner thermoplastic pipe 220. In an example, the inner thermoplastic pipe 220 may include one or more of polyvinyl chloride (PVC), polypropylene (PP), polyethylene (PE), nylon, acrylonitrile butadiene styrene (ABS), or other thermoplastic.

The bonding layer material 250 may surround the inner thermoplastic pipe 220 and may be partially embedded within the inner thermoplastic pipe 220. The bonding layer material 250 may include one or more of a strand, tape, or sheet. The bonding layer material 250 may be one or more of a permeable mesh or fabric applied to the inner thermoplastic pipe 220. The bonding layer material 250 may be not be solid but may have pores or gaps, such as may allow a material (e.g. the inner thermoplastic pipe 220 and/or the fiber reinforced laminate 260) to flow or seep through the bonding layer material 250.

The bonding layer material 250 may form a mechanical bond with the inner thermoplastic pipe 220 by being partially embedded within an outer surface of the inner thermoplastic pipe 220. For example, an outer portion of the inner thermoplastic pipe 220 may surround a portion of the bonding layer material 250, such as a portion of one or more of the strands or filaments in the bonding layer material 250. In an example, the inner thermoplastic pipe 220 and the bonding layer material 250 may also form a chemical bond, such as may include intermolecular forces (e.g. Van der Walls forces). In an example, the inner thermoplastic pipe 220 and the bonding layer material 250 may predominantly form a mechanical bond, such as may result in the bonding layer material 250 being mechanically attached to the inner thermoplastic pipe 220 without a strong chemical bond.

The bonding layer material 250 may be selected or configured to form a strong chemical bond with a glue or resin used in the fiber reinforced laminate 260. In an example, the bonding layer material 250 may form a strong chemical bond with one or more of an epoxy or polyester resin used in the fiber reinforced laminate 260. The glue or resin used in the fiber reinforced laminate 260 may seep through or into the bonding layer material 250 to form a mechanical bond with the bonding layer material 250. The bonding layer material 250 may be configured or selected to have a specified tensile strength such as may allow the bonding layer material 250 to hold the inner thermoplastic pipe 220 and the outer layer of fiber reinforced laminate 260 together.

The one or more outer layers of fiber reinforced laminate 260 may surround the inner thermoplastic pipe 220 and the bonding layer material 250, and may be bonded to one or more of the inner thermoplastic pipe 220 or the bonding layer material 250. The outer layer of fiber reinforced laminate 260 may include one or more of a strand, tape, or sheet. The outer layer of fiber reinforced laminate 260 may be reinforced, such as may include reinforcement with a fiber such as may include one or more of fiberglass or carbon fiber. The outer layer of fiber reinforced laminate 260 may include a laminate formed using a glue or resin, such as may include one or more of epoxy resin or polyester resin. There may be multiple overlapping outer layers of fiber reinforced laminate 260, such as may include one layer, two layers, three layers, four layers, or five layers, as illustrative examples. In an example, the one or more outer layers of fiber reinforced laminate 260 may include one or more of epoxy resin and fiberglass laminate, an epoxy resin and carbon fiber laminate, a polyester resin and fiberglass laminate, or an epoxy resin, fiberglass, and carbon fiber laminate.

The thermoplastic wear-resistant layer 270 may be an outer layer of the pipe 110. The thermoplastic wear-resistant layer 270 may be applied over the one or more layers of fiber reinforced laminate 260. The thermoplastic wear-resistant layer 270 may be configured or selected to provide one or more desirable properties such as may include wear resistance, impact resistance, or visibility. The thermoplastic wear-resistant layer 270 may protect the one or more layers of fiber reinforced laminate 260 from the environment the pipe 110 is installed in. The 270 may include one or more of polyvinyl chloride (PVC), polypropylene (PP), polyethylene (PE), nylon, acrylonitrile butadiene styrene (ABS), or other material.

One or more of the inner thermoplastic pipe 220 or the bonding layer material 250 may include an induction heating compatible material (IHCM) The IHCM may be disposed within one or more of the inner thermoplastic pipe 220 or the bonding layer material 250, or as a distinct layer between the inner thermoplastic pipe 220 and the bonding layer material 250. At least a portion of the IHCM may be electrically conductive or magnetic (e.g., magnetically permeable), such as may allow for the formation of currents within the IHCM. The IHCM may include a metal, such as iron or copper. The IHCM may include a metalloid or nonmetal, such as carbon. In an example, the IHCM may be carbon fiber, such as may include one or more of a carbon fiber filament, strand, mesh, mat, or fabric.

The IHCM may be included within one or more regions of the inner thermoplastic pipe 220. The IHCM may be included within one or more regions of the bonding layer material 250. The IHCM may be applied to an outer layer or face of one or more of the inner thermoplastic pipe 220 or the bonding layer material 250. The IHCM may be coextruded onto the surface of the inner thermoplastic pipe 220, such as may include being coextruded at the same time the inner thermoplastic pipe 220 is formed. The inner thermoplastic pipe 220 may be doped with an IHCM in one or more regions, such as a coextruded outer region, at a level necessary to generate heat but without introducing unnecessary inclusions or impurities in the inner thermoplastic pipe 220.

In some examples, the bonding layer material 250 may include the IHCM. In an example, the bonding layer material 250 may include a porous tape including carbon or another conductor. The porous tape may provide the IHCM and also have desirable bonding properties with the fiber reinforced laminate 260.

The IHCM may be configured to provide heat through induction heating. The IHCM may be configured to provide heat for embedding the bonding layer material 250 within the inner thermoplastic pipe 220.

At least a portion of the pipe 110 may be conductive to electricity along a length of the pipe 110, such as may be due to the presence of the IHCM. For example, there may be a relatively low resistance path for electrons to travel along a length of pipe 110. This may allow the pipe 110 to be electrically grounded, such as may lower the risk of a static discharge igniting a fire.

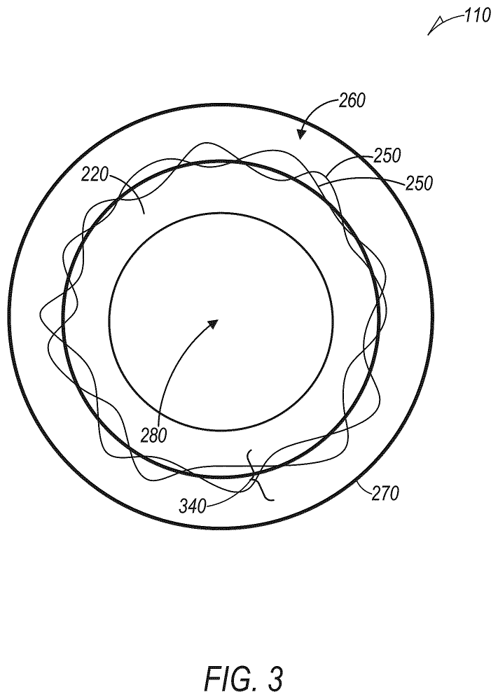

FIG. 3 is a cross-sectional view of an example of a portion of the pipe of FIG. 2. FIG. 3 shows the inner thermoplastic pipe 220, the bonding layer material 250, the outer layer of fiber reinforced laminate 260, and the thermoplastic wear-resistant layer 270. FIG. 3 shows that an inner surface of the inner thermoplastic pipe 220 defines the bore 280 within the pipe 110. FIG. 3 also shows the bonding region 340, including the bonding layer material 250 being one or more of at partially surrounded by, partially embedded within, or otherwise entangled with the inner thermoplastic pipe 220. FIG. 3 shows that the bonding region 340 can include the bonding layer material 250 being one or more of partially surrounded by, partially embedded within, or otherwise entangled with the outer layer of fiber reinforced laminate 260.

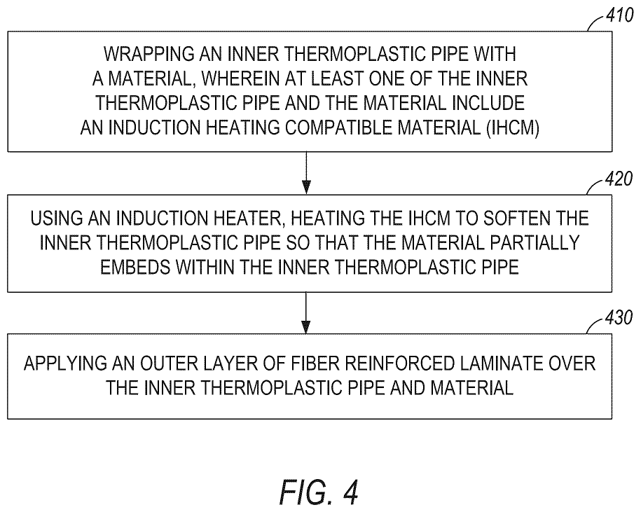

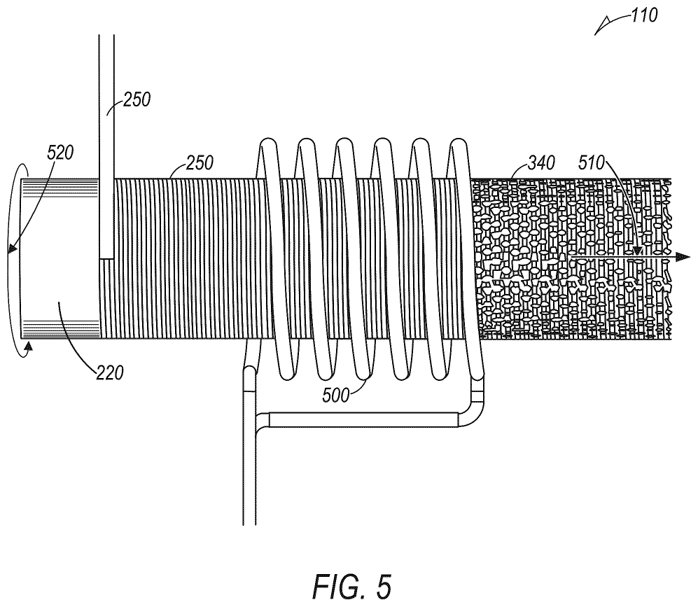

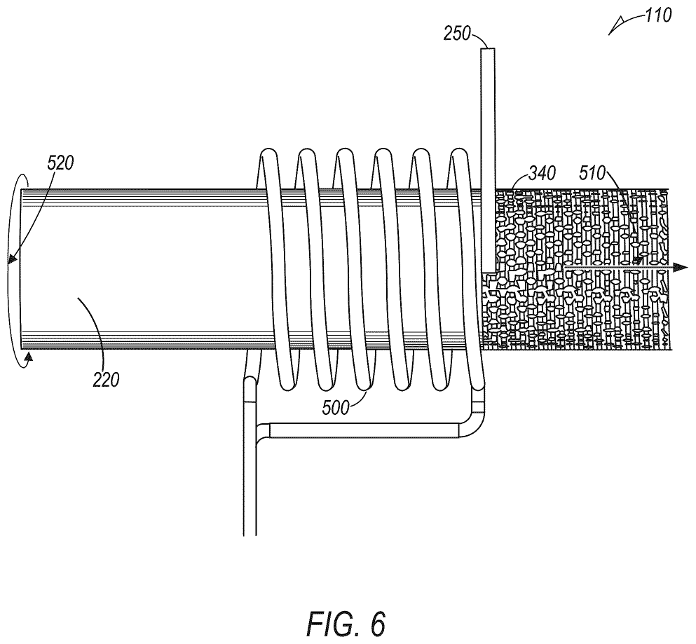

FIGS. 4-6 illustrate a process for forming a pipe 110. In particular, FIG. 4 is a flow chart showing an example of a method for manufacturing portions of a pipe 110. FIGS. 5-6 show a perspective view of an example of portions of a pipe 110 being manufactured and portions of the system for manufacturing the pipe. For example, and as shown in FIG. 5, an inner thermoplastic pipe 220 may be wrapped 410 with a material 250, where at least one of the inner thermoplastic pipe 220, or the material 250, includes an induction heating compatible material (IHCM). The IHCM may be included in one or more of the inner thermoplastic pipe 220 or the bonding layer material 250. The IHCM may be applied to at least a portion of a face of one or more of the inner thermoplastic pipe 220 or the bonding layer material 250.

The bonding layer material 250 may be wrapped onto the inner thermoplastic pipe 220 in at least one of a tape, strand, or sheet. The pipe 110 may rotate in direction of arrow 520 to wrap the bonding layer material 250 onto the inner thermoplastic pipe 220. In an example, a portion of the bonding layer material 250 may overlap with itself. In an example, the bonding layer material 250 may equally cover each portion of the inner thermoplastic pipe 220. In an example, the bonding layer material 250 may not cover each portion of the inner thermoplastic pipe 220, and there may be gaps between respective wraps of the bonding layer material 250.

The IHCM may be heated 420 using an induction heater to soften the inner thermoplastic pipe 220 so that the material 250 can partially embed within the inner thermoplastic pipe 220. For example, the pipe may be passed through an induction heater including an induction heating coil 500 and an induction heating driver. In FIG. 5, the inner thermoplastic pipe 220 may be wrapped with the bonding layer material 250 before being heated using the induction heater. This may allow the IHCM to be within, on, or between one or more of the inner thermoplastic pipe 220 or the bonding layer material 250. In an example, the inner thermoplastic pipe 220 and the bonding layer material 250 may both contain an IHCM. In an example, the IHCM may be positioned close to the outer surface of the inner thermoplastic pipe 220, such as may allow for more directed heating of only the outer surface of the inner thermoplastic pipe 220. In an example, placing the IHCM near the outer surface of the inner thermoplastic pipe 220 may allow the outer surface of the inner thermoplastic pipe 220 to soften sufficiently for the bonding layer material 250 to embed without the inner thermoplastic pipe 220 losing structural integrity, such as may be due to an inner region of the inner thermoplastic pipe 220 remaining at a lower temperature where it maintains a degree of structural rigidity. This may help the manufacturing process by allowing the inner thermoplastic pipe 220 to one or more of support itself or maintain shape during the embedding of the IHCM. In an example, placing the IHCM near the outer surface of the inner thermoplastic pipe 220 may reduce the amount of heat that is needed to form the pipe.

In FIG. 6, the bonding layer material 250 may be wrapped on the inner thermoplastic pipe 220 after the inner thermoplastic pipe 220 is heated with the induction heater. This may require the IHCM to be within or on the inner thermoplastic pipe 220, such that the IHCM is present when the pipe 110 passes through the induction heating coil 500. In FIG. 6, because the inner thermoplastic pipe 220 may be softened when the bonding layer material 250 is being wrapped onto the pipe, a tension or force on the bonding layer material 250 may be applied to help partially embed the bonding layer material 250 within the inner thermoplastic pipe 220.

The induction heating coil 500 may be wrapped around a portion of the pipe 110. The induction heating coil 500 may not be required to touch the pipe 110 or the IHCM to heat the IHCM. The 500 may be a conductive coil, such as may include a conductive coil of copper or other metal. The induction heating coil 500 may be driven by an induction heating driver, such as may produce an alternating current of a specified amplitude and frequency. In an example, the frequency of the alternating current may be relatively high, such as may include between 1000 Hz and 100,000 Hz, between 5,000 Hz and 50,000 Hz, or 10,000 Hz, as illustrative examples. The induction heating coil 500 may induce a current in at least a portion of the IHCM which may cause the IHCM to heat up due to resistive losses. The heat from the IHCM may be passed by conduction to the surrounding materials (e.g. the inner thermoplastic pipe 220 or the bonding layer material 250), which may result in the bonding layer material 250 partially embedding within the inner thermoplastic pipe 220.

The pipe may travel in the direction 510 at a specified speed such as may allow the induction heating coil 500 to heat the IHCM and embed the bonding layer material 250 in the inner thermoplastic pipe 220. The speed of travel in direction 510 may be configurable, such as may allow an operator or computer to adjust the manufacturing process. One or more of the power output or other parameters of the induction heating coil 500 may be configurable, such as may allow an operator or computer to adjust the manufacturing process. In an example, one or more of the speed of travel or the parameters of the induction heating coil 500 may be adjusted based upon a monitored condition of the pipe 110, such as may include one or more of the temperature of the pipe exiting the induction heating coil 500, or the degree to which the bonding layer material 250 is embedded within the inner thermoplastic pipe 220.

An outer layer of fiber reinforced laminate 260 may be applied 430 over the inner thermoplastic pipe 220 and bonding layer material 250. The outer layer of fiber reinforced laminate fiber reinforced laminate 260 may include an epoxy or polyester resin combined with fiberglass or carbon fiber, as illustrative examples. For example, a layer of fiber may be wrapped onto the pipe 110 and then a resin may be applied to soak into or penetrate the fiber and bond the fibers together and the fiber reinforced laminate 260 to the bonding layer material 250 and inner thermoplastic pipe 220. In an example, a fiber that is pre-impregnated or otherwise soaked with resin may be wrapped onto the pipe 110. The outer layer of fiber reinforced laminate 260 may be selected or configured to form a strong bond with the bonding layer material 250. For example, the bonding layer material 250 may include one or more of carbon fiber, fiberglass, metallic wire, metallic mesh, metallic foil, or perforated metallic foil, which may form a strong bond with the resin used in the fiber reinforced laminate 260.

FIG. 4 illustrates an example of a method for manufacturing pipe 110. The shown order of steps is not intended to be a limitation on the order the steps are performed in. In an example, two or more steps may be performed simultaneously or at least partially concurrently. In an example, one or more steps may be omitted. In an example, one or more steps may be added.

Step 410 and step 420 may be performed simultaneously or at least partially concurrently. For example, the bonding layer material 250 may be wrapped onto a portion of the inner thermoplastic pipe 220 at the same time as at least one of (1) the portion being wrapped or (2) another portion of the pipe 110 is being heated by the induction heating coil 500. In the example of FIG. 5, one portion of the inner thermoplastic pipe 220 may be wrapped with the bonding layer material 250 while a previously wrapped portion of the inner thermoplastic pipe 220 may be heated using the induction heating coil 500. In the example of FIG. 6, one portion of the inner thermoplastic pipe 220 may be heated using the induction heating coil 500 while a previously heated portion of the inner thermoplastic pipe 220 may be wrapped with the bonding layer material 250.

The pipe 110 may be manufactured in an ongoing or substantially continuous manufacturing or production process. The ongoing manufacturing process may include manufacturing a specified length of pipe without a significant stoppage or break in the manufacturing process. The wrapping of the inner thermoplastic pipe 220 may occur in a substantially continuous fashion. The heating of the pipe 110 by the induction heating coil 500 may also occur in a substantially continuous fashion. For example, the pipe 110 may move at a specified speed longitudinally in the direction 510 to create a continuous production process. The pipe 110 may move continuously for a portion of the manufacturing process. While the pipe 110 is moving, the induction heating coil 500 may heat different portions of the pipe 110. For example, when a portion of the pipe 110 enters the induction heating coil 500, it may begin being heated and when a portion of the pipe 110 exits the induction heating coil 500, it may have been heated enough to allow the bonding layer material 250 to partially embed within the inner thermoplastic pipe 220.

While the pipe is traveling in direction 510, the wrapping of the bonding layer material 250 may be occurring substantially continuously, such as may be due to the rotation of the pipe 110 in the direction of the arrow 520 or by revolving the material around the non-rotating pipe. This may result in the inner thermoplastic pipe 220 being wrapped consistently by the bonding layer material 250. The continuous production process of the pipe 110 may be one or more of more efficient, quicker, or may result in a product that is more consistent or has more desirable properties (e.g. strength and durability) than a batch-manufactured pipe. The fiber reinforced laminate 260 may be applied in a similar continuous wrapping fashion to the bonding layer material 250, or the application may differ in one or more ways. In example, the pipe is stored and allowed to cool before the fiber reinforced laminate 260 is applied in step 430. In an example, the fiber reinforced laminate 260 is applied shortly after the bonding layer material 250. For example, step 410, step 420, and step 430 may all occur at least partially concurrently.

In an example, the pipe 110 may be heated using both an induction heater and another heat source. For example, the pipe 110 may be heated using radiant or convection heating as well as induction heating. In an example, the inner thermoplastic pipe 220 may be preheated using a radiant heater and then passed through the induction heating coil 500 to accomplish the embedding of the bonding layer material 250. In an example, the preheating process may be accomplished by using one or more of a warm manufacturing environment, a preheated inner thermoplastic pipe 220, or a preheated bonding layer material 250 In an example, the inner thermoplastic pipe 220 may be extruded in a substantially continuous process along with the manufacturing of the pipe 110, which may provide a degree of heat for the embedding of the bonding layer material 250.

In a case where the IHCM is applied as a distinct layer between the inner thermoplastic pipe 220 and bonding layer material 250, the IHCM may be permeable to allow thermoplastic material to seep through the IHCM. For example, the inner thermoplastic pipe 220 may seep through the IHCM to embed the bonding layer material 250 within the inner thermoplastic pipe 220.

In a case where the IHCM is included in the inner thermoplastic pipe 220, the IHCM may be infused within the outer layer of the inner thermoplastic pipe 220. For example, carbon fibers in the form of a strand, mat, or fabric may be infused in a thermoplastic material to form the outer layer of the inner thermoplastic pipe 220.

The method of FIG. 4 may include supplying the IHCM in at least one of a specified quantity of specified form to result in a pipe 110 that is electrically conductive. For example, the IHCM may be supplied in a sufficient quantity to result in a pipe of a desired level of conductivity. In an example, a specified form of IHCM may result in a conductive pipe, such as a fabric or strand that spans a length of pipe. The IHCM may be applied in at least one of a specified form or a specified quantity such that the IHCM does not adversely affect one or more properties of the pipe 110, such as may include strength and rigidity.

The present devices and methods are believed to apply to a range of potential applications, which is not limited to spoolable plastic pipe. For example, these devices and methods may apply to non-spoolable pipe that is manufactured and transported in straight sections. For example, these devices and methods may apply to a pipe whose inner liner of pipe is not thermoplastic but may behave similar to a thermoplastic (i.e. melting when heated). For example, these devices and methods may apply to a device that is not a pipe, but may be a tank, tube, or other similar device that includes a bonding material embedded within an inner portion.

### EXAMPLES

Example 1 is a pipe comprising: an inner thermoplastic pipe; an outer layer of a fiber reinforced laminate; and a bond material, disposed between the inner thermoplastic pipe and the outer layer of fiber reinforced laminate, wherein the bond material is partially embedded within the inner thermoplastic pipe, wherein at least one of the inner thermoplastic pipe or the bond material include an induction heating compatible material (IHCM).

In Example 2, the subject matter of Example 1 optionally includes wherein the IHCM is configured to provide heat through induction heating for partially embedding the bond material within the inner thermoplastic pipe.

In Example 3, the subject matter of any one or more of Examples 1-2 optionally include wherein the bond material includes at least one of a strand, tape, or sheet.

In Example 4, the subject matter of any one or more of Examples 1-3 optionally include wherein the bond material is permeable to allow a portion of the inner thermoplastic pipe to seep through a portion of the bond material.

In Example 5, the subject matter of Example 4 optionally includes wherein a bond between an inner thermoplastic layer and the bond material includes a mechanical bond and wherein a bond between the outer layer of fiber reinforced laminate and the bond material includes a chemical bond.

In Example 6, the subject matter of any one or more of Examples 1-5 optionally include wherein the inner thermoplastic pipe includes an IHCM.

In Example 7, the subject matter of Example 6 optionally includes wherein the inner thermoplastic pipe includes an IHCM that is coextruded onto a surface of the inner thermoplastic pipe.

In Example 8, the subject matter of any one or more of Examples 6-7 optionally include wherein the IHCM is included as an additive in the inner thermoplastic pipe.

In Example 9, the subject matter of any one or more of Examples 1-8 optionally include wherein the bond material includes an IHCM.

In Example 10, the subject matter of any one or more of Examples 1-9 optionally include wherein the IHCM includes carbon fiber.

In Example 11, the subject matter of any one or more of Examples 1-10 optionally include wherein the pipe is electrically conductive.

In Example 12, the subject matter of any one or more of Examples 1-11 optionally include wherein the fiber reinforced laminate includes fiberglass.

In Example 13, the subject matter of any one or more of Examples 1-12 optionally include wherein the fiber reinforced laminate includes epoxy.

Example 14 is a method of manufacturing a pipe, the method comprising wrapping an inner thermoplastic pipe with a bond material, wherein at least one of the inner thermoplastic pipe and the bond material include an induction heating compatible material (IHCM); using an induction heater, heating the IHCM to soften the inner thermoplastic pipe so that the bond material partially embeds within the inner thermoplastic pipe; and applying an outer layer of fiber reinforced laminate over the inner thermoplastic pipe and bond material.

In Example 15, the subject matter of Example 14 optionally includes wherein the using an induction heater occurs after the wrapping an inner thermoplastic pipe with a bond material.

In Example 16, the subject matter of Example 15 optionally includes wherein the bond material includes an IHCM.

In Example 17, the subject matter of any one or more of Examples 14-16 optionally include wherein the using an induction heater occurs before the wrapping an inner thermoplastic pipe with a bond material.

In Example 18, the subject matter of Example 17 optionally includes wherein the inner thermoplastic pipe includes an IHCM.

In Example 19, the subject matter of any one or more of Examples 17-18 optionally include applying an IHCM to a surface of the inner thermoplastic pipe.

In Example 20, the subject matter of any one or more of Examples 14-19 optionally include carrying out the method substantially continuously along a length of pipe.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A pipe comprising:
an inner thermoplastic pipe;
an outer layer of a fiber reinforced laminate; and
a bond material, disposed between the inner thermoplastic pipe and the outer layer of fiber reinforced laminate, wherein the bond material is partially embedded within the inner thermoplastic pipe, wherein at least one of the inner thermoplastic pipe or the bond material include an induction heating compatible material (IHCM).

2. The pipe of claim 1, wherein the IHCM is configured to provide heat through induction heating for partially embedding the bond material within the inner thermoplastic pipe.

3. The pipe of claim 1, wherein the bond material includes at least one of a strand, tape, or sheet.

4. The pipe of claim 1, wherein the bond material is permeable to allow a portion of the inner thermoplastic pipe to seep through a portion of the bond material.

5. The pipe of claim 4, wherein a bond between an inner thermoplastic layer and the bond material includes a mechanical bond and wherein a bond between the outer layer of fiber reinforced laminate and the bond material includes a chemical bond.

6. The pipe of claim 1, wherein the inner thermoplastic pipe includes an IHCM.

7. The pipe of claim 6, wherein the inner thermoplastic pipe includes an IHCM that is coextruded onto a surface of the inner thermoplastic pipe.

8. The pipe of claim 6, wherein the IHCM is included as an additive in the inner thermoplastic pipe.

9. The pipe of claim 1, wherein the bond material includes an IHCM.

10. The pipe of claim 1, wherein the IHCM includes carbon fiber.

11. The pipe of claim 1, wherein the pipe is electrically conductive.

12. The pipe of claim 1, wherein the fiber reinforced laminate includes fiberglass.

13. The pipe of claim 1, wherein the fiber reinforced laminate includes epoxy.

14. A method of manufacturing a pipe, the method comprising:
wrapping an inner thermoplastic pipe with a bond material, wherein at least one of the inner thermoplastic pipe and the bond material include an induction heating compatible material (IHCM);
using an induction heater, heating the IHCM to soften the inner thermoplastic pipe so that the bond material partially embeds within the inner thermoplastic pipe; and
applying an outer layer of fiber reinforced laminate over the inner thermoplastic pipe and bond material.

15. The method of claim 14, wherein the using an induction heater occurs after the wrapping an inner thermoplastic pipe with a bond material.

16. The method of claim 15, wherein the bond material includes an IHCM.

17. The method of claim 14, wherein the using an induction heater occurs before the wrapping an inner thermoplastic pipe with a bond material.

18. The method of claim 17, wherein the inner thermoplastic pipe includes an IHCM.

19. The method of claim 17, further comprising applying an IHCM to a surface of the inner thermoplastic pipe.

20. The method of claim 14, further comprising carrying out the method substantially continuously along a length of pipe.
